(19) United States
(12) Patent Application Publication
(10) Pub. No.: US 2014/0146564 A1
(43) Pub. Date: May 29, 2014

(54) BACKLIGHT UNIT AND DISPLAY APPARATUS HAVING THE SAME

(71) Applicant: Samsung Display Co., Ltd., Yongin-city (KR)

(72) Inventors: Hyun-Deok IM, Seoul (KR); Oleg Prudnikov, Suwon-si (KR); Byoung-Ho Cheong, Yongin-si (KR); Hyun-Jin Cho, Seoul (KR); Guk-Hyun Kim, Hwaseong-si (KR)

(73) Assignee: Samsung Display Co., Ltd., Yongin-city (KR)

(21) Appl. No.: 13/972,660

(22) Filed: Aug. 21, 2013

(30) Foreign Application Priority Data
Nov. 23, 2012 (KR) 10-2012-0133867

(51) Int. Cl. F21V 8/00

(52) U.S. Cl. CPC G02B 6/0088
USPC 362/607; 362/606

(57) ABSTRACT

A backlight unit includes a light source part, a light guide plate, a prism sheet, and a reflecting element. The light source part is configured to provide light. The light guide plate includes: a light incident portion disposed adjacent to the light source part, a corresponding portion spaced apart from and facing the light incident portion, a light exiting surface, and a bottom surface spaced apart from and facing the light exiting surface. A thickness of the light incident portion is greater than a thickness of the corresponding portion. The prism sheet is disposed on the light guide plate. The prism sheet includes a plurality of prisms extending toward the light guide plate. The reflecting element is disposed under the light guide plate. The reflecting element is configured to reflect at least some of the light toward the light guide plate.

### CROSS-REFERENCE TO RELATED APPLICATION

This application claims priority from and the benefit of Korean Patent Application No. 10-2012-0133867, filed on Nov. 23, 2012, which is incorporated by reference for all purposes as if set forth herein.

### BACKGROUND

1. Field

Exemplary embodiments relate to display technology, and more particularly, to backlight units and display devices including the same.

2. Discussion

Non-self-emissive display devices, such as liquid crystal display (LCD) devices, electrophoretic display (EPD) devices, electrowetting display (EWD) devices, and the like, do not generate light by themselves. In this manner, non-self-emissive display devices utilize a light source to display an image at a desired luminance. For instance, an LCD device may include a light source, such as a backlight unit.

Conventional backlight units typically include a light source and a light guide plate configured to guide light received from the light source. For example, the light guide plate may be configured to uniformly provide light provided to a side surface of the light guide plate to a display module disposed on the light guide plate. As such, the light guide plate may provide uniform light to, for example, a liquid crystal panel in accordance with a desired viewing angle distribution.

FIG. 1A is a cross-sectional view of a path of light propagating through an ideal light guide plate. FIG. 1B is a cross-sectional view of a path of light propagating through a light guide plate including a defective portion. FIG. 1C is a plan view of a light emitting distribution of the light guide plate of FIG. 1B. FIG. 1D is a graph of a viewing angle distribution of the light guide plate of FIG. 1B.

Referring to FIG. 1A, an ideal backlight unit may include a light guide plate 11 and 12 and a reflecting element 20. Light is incident to light incident surface 11. The light incident is reflected at a corresponding surface 12 facing the light incident surface 11 and exits through a light exiting surface facing the reflecting element 20. Thus, light may be uniformly provided to a display module disposed, for instance, on the backlight unit. However, the ideal light guide plate 11, 12 shown in FIG. 1A is hard to manufacture.

Referring to FIG. 1B, the light guide plate 11, 12 includes a defective portion 15. The defective portion 15 may be generated as a result of differences in thermal characteristics between two mediums, such as an injection metal and an injection solvent, when the light guide plate 11, 12 is being manufactured. The light guide plate 11, 12 including the defective portion 15 may cause one or more relatively dark portions (or spots), e.g., dark portions b1, b2 and b3, to be produced as compared to the ideal light guide plate 11, 12 of FIG. 1A.

Referring to FIG. 1C, the dark portions b1, b2 and b3 resulting from light reflecting and refracting off of the defective portion 15 may cause an upper light distribution elu of the light guide plate 11, 12 including the defective portion 15 and a lower light distribution ell of the light guide plate 11, 12 including the defective portion 15 to be produced. The upper light distribution elu of the light guide plate 11, 12 including the defective portion 15 and the lower light distribution ell of the light guide plate 11, 12 including the defective portion 15 may have substantially the same pattern, such that dark spots and bright portions are more clearly shown in a light exiting distribution elf of the light guide plate 11, 12 including the defective portion 15. Referring to FIG. 1D, an upper viewing angle eu of the light guide plate 11, 12 including the defective portion 15 and a lower viewing angle el of the light guide plate 11, 12 including the defective portion 15 are represented in the depicted graph. As explained above, the upper viewing angle eu of the light guide plate 11, 12 including the defective portion 15 and the lower viewing angle el of the light guide plate 11, 12 including the defective portion 15 may have substantially the same pattern, such that an exiting viewing angle to of the light guide plate 11, 12 including the defective portion 15 has a small range.

Accordingly, when the defective portion 15 is generated on the light guide plate 11, 12, the dark spots and bright portions are shown, such that one or more stripe (or interference) patterns (e.g., moiré fringes) may be produced, and the viewing angle of light exiting the light guide plate 11, 12 may be narrow. Therefore, there is a need for an approach that provides efficient, cost effective techniques to provide non-self-emissive display devices with improved, uniform brightness characteristics.

The above information disclosed in this Background section is only for enhancement of understanding of the background of the invention and therefore it may contain information that does not form the prior art that is already known in this country to a person of ordinary skill in the art.

### SUMMARY

Exemplary embodiments provide a backlight unit including an adjusted gap between a light guide plate and a reflecting element configured to prevent (or otherwise reduce) the presence of light interference patterns (e.g., moiré fringes) that would otherwise result from the reflection and refraction of light off one or more defects in the light guide plate of the backlight unit.

Exemplary embodiments provide a display apparatus including the backlight unit.

Additional aspects will be set forth in the detailed description which follows and, in part, will be apparent from the disclosure, or may be learned by practice of the invention.

According to exemplary embodiments, a backlight unit includes a light source part, a light guide plate, a prism sheet and a reflecting element. The light source part is configured to provide light. The light guide plate includes: a light incident portion disposed adjacent to the light source part, a corresponding portion spaced apart from and facing the light incident portion, a light exiting surface, and a bottom surface spaced apart from and facing the light exiting surface. A thickness of the light incident portion is greater than a thickness of the corresponding portion. The prism sheet is disposed on the light guide plate. The prism sheet includes a plurality of prisms extending toward the light guide plate. The reflecting element is disposed under the light guide plate. The reflecting element is configured to reflect at least some of the light toward the light guide plate.

According to exemplary embodiments, a display apparatus includes a backlight unit and a display panel configured to display an image using light received from the backlight unit. The backlight unit includes a light source part, a light guide plate, a prism sheet, and a reflecting element. The light source part is configured to provide light. The light guide plate includes: a light incident portion disposed adjacent to the light source part, a corresponding portion spaced apart from and facing the light incident portion, a light exiting surface, and a bottom surface spaced apart from and facing the light exiting surface. A thickness of the light incident portion is greater than a thickness of the corresponding portion. The prism sheet is disposed on the light guide plate. The prism sheet includes a plurality of prisms extending toward the light guide plate. The reflecting element is disposed under the light guide plate. The reflecting element is configured to reflect at least some of the light toward the light guide plate.

According to exemplary embodiments, a reflecting element is spaced apart from a light guide plate to adjust a light distribution pattern of light exiting the light guide plate. As such, light interference patterns may be reduced (or otherwise prevented) even though the light guide plate includes one or more defective portions generated, for example, during one or more manufacturing processes.

According to exemplary embodiments, an inclined angle between a reflecting element and a light guide plate is adjusted to control a light distribution pattern of light exiting the light guide plate. As such, light exiting the light guide plate may exhibit a wider viewing angle distribution despite the presence of one or more defective portions in the light guide plate.

According to exemplary embodiments, a focal length between a condensing lens and a pixel of a display device including the backlight unit may be adjusted, such that light interference patterns due to differences in light paths of multiple light sources through the light guide plate may be prevented (or otherwise reduced). As such, a display device including the backlight unit may be manufactured without a color filter.

According to exemplary embodiments, a focal length between a condensing lens and a pixel of a display device including the backlight unit may be adjusted, such that light interference patterns due to differences in light paths of multiple light sources through the light guide plate may be prevented (or otherwise reduced). As such, the light guide plate including a rectangular shape without a curved corresponding side may be manufactured, which enables a bezel of the display device to be decreased.

The foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1A is a cross-sectional view of a path of light in an ideal light guide plate.

FIG. 1B is a cross-sectional view of a path of light in a light guide plate including a defective portion.

FIG. 1C is a plan view of a light emitting distribution of the light guide plate of FIG. 1B.

FIG. 1D is a graph of a viewing angle distribution of the light guide plate of FIG. 1B.

FIG. 2A is a cross-sectional view of a display apparatus, according to exemplary embodiments.

FIG. 2B is a plan view of a light source and a light guide plate of the display apparatus of FIG. 2A, according to exemplary embodiments.

FIG. 3 is a cross-sectional view of a light guide plate and a reflecting element of a backlight unit, according to exemplary embodiments.

FIG. 4 is a cross-sectional view of a path of light through the backlight unit of FIG. 3, according to exemplary embodiments.

FIG. 5 is a cross-sectional view of a light exiting distribution of the light guide plate of FIG. 3, according to exemplary embodiments.

FIG. 6 is a cross-sectional view of a backlight unit, according to exemplary embodiments.

FIG. 7 is a graph of a viewing angle distribution of the backlight unit of FIG. 6, according to exemplary embodiments.

FIGS. 8A-8D are cross-sectional views of backlight units, according to exemplary embodiments.

FIG. 9 is a conceptual diagram of a display apparatus, according to exemplary embodiments.

FIG. 10 is a conceptual diagram of the display apparatus of FIG. 9, according to exemplary embodiments.

FIG. 11 is a conceptual diagram of a backlight unit of the display apparatus of FIG. 9, according to exemplary embodiments.

FIGS. 12A and 12B are cross-sectional views of the backlight unit of FIG. 9, according to exemplary embodiments.

FIG. 13 is a plan view of a backlight unit, according to exemplary embodiments.

FIGS. 14A and 14B are cross-sectional views of backlight units, according to exemplary embodiments.

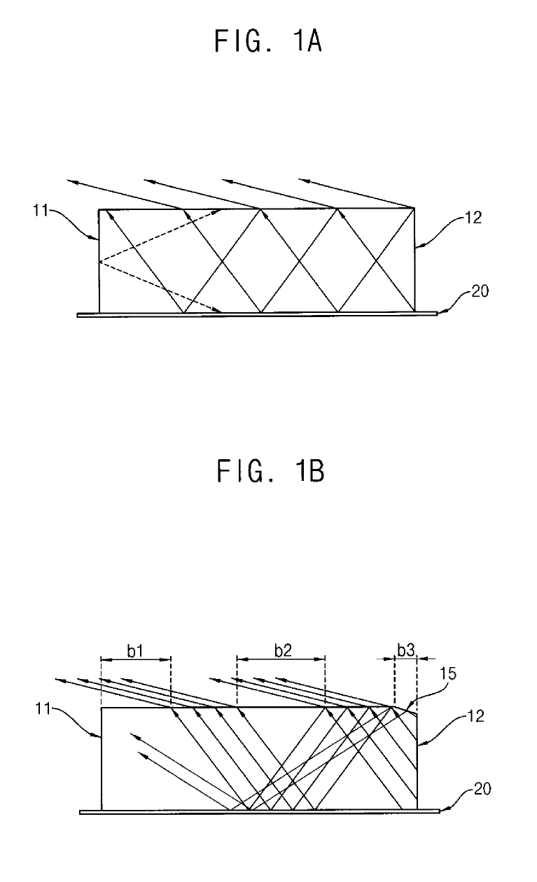

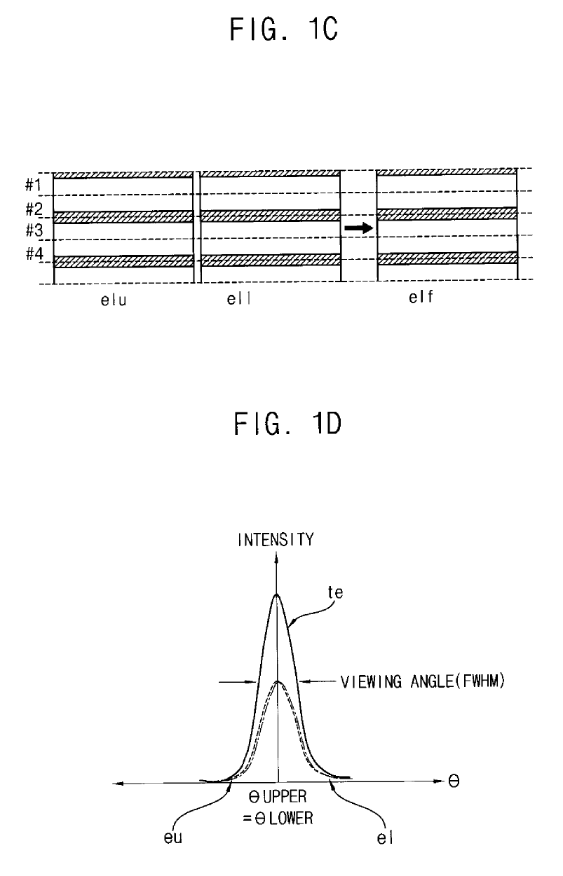

### DETAILED DESCRIPTION OF EXEMPLARY EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers and/or sections, these elements, components, regions, layers and/or sections should not be limited by these terms. These terms are used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath,” “below,” “lower,” “above,” “upper,” and/or the like, may be used herein for descriptive purposes, and thereby, to describe one element or feature's relationship to another element(s) or feature(s) as illustrated in the drawings. Spatially relative terms are intended to encompass different orientations of an apparatus in use or operation in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and as such, the spatially relative descriptors used herein interpreted accordingly.

The terminology used herein is for the purpose of describing particular embodiments and is not intended to be limiting. As used herein, the singular forms “a,” “an,” and “the” are intended to include the plural forms as well, unless the context clearly indicates otherwise. Moreover, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

While exemplary embodiments are described in association with a liquid crystal display device, it is contemplated that exemplary embodiments may be utilized in association with other or equivalent display devices, such as electrophoretic display (EPD) devices, electrowetting display (EWD) devices, and/or the like.

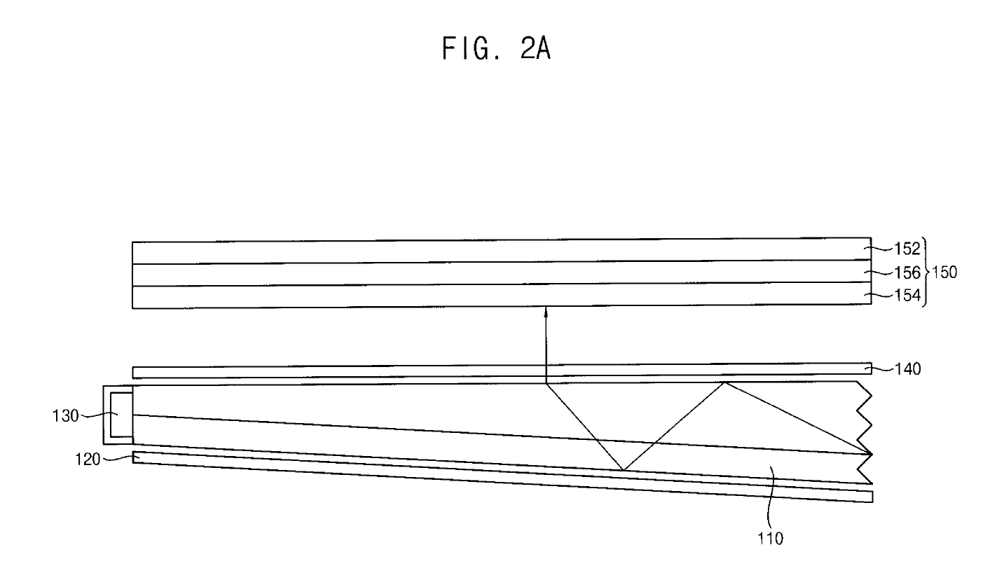

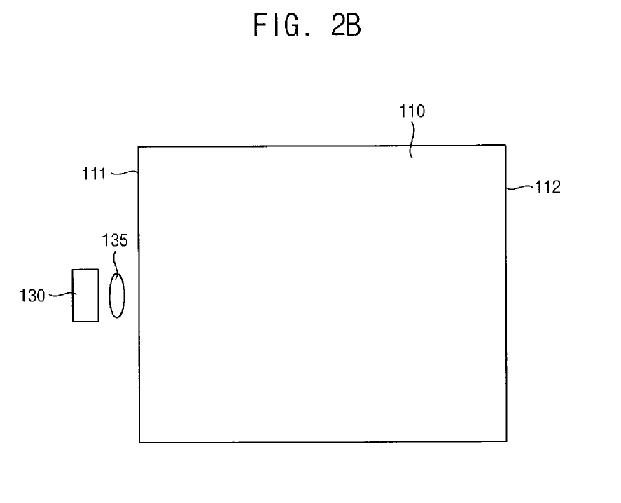

FIG. 2A is a cross-sectional view of a display apparatus, according to exemplary embodiments. FIG. 2B is a plan view of a light source and a light guide plate of the display apparatus of FIG. 2A.

Referring to FIGS. 2A and 2B, the display apparatus includes a display panel 150 and a backlight unit configured to provide light to the display panel 150.

The display panel 150 includes an array substrate 154 including a thin film transistor array (not shown), a corresponding substrate 152 spaced apart from and facing the array substrate 154, and a liquid crystal layer 156 disposed between the array substrate 154 and the corresponding substrate 152. According to exemplary embodiments, the display panel 150 is configured to adjust a light transmittance of light received from the backlight unit to display an image.

According to exemplary embodiments, the backlight unit includes a light source part 130, a light guide plate 110, and a reflecting element 120. The light guide plate 110 includes a light incident portion (or surface) 111, a corresponding portion (or surface) 112 spaced apart from and facing the light incident portion 111, a light exiting portion (or surface), and a bottom portion (or surface) spaced apart from and facing the light exiting surface. The corresponding portion 112 is configured to reflect light incident from the light incident portion 111. The light guide plate 110 may have a wedge shape; however, any other suitable shape may be utilized. When configured as a wedge, a thickness of the light incident portion 111 may be greater than a thickness of the corresponding portion 112. The reflecting element 120 may be disposed under the light guide plate 110. That is, the light guide plate 110 may be disposed between the reflecting element 120 and the display panel 150. The backlight unit may further include a prism sheet 140. The prism sheet 140 is disposed on the light guide plate 110. For instance, the prism sheet 140 may be disposed between the display panel 150 and the light guide plate 110. The prism sheet 140 includes a plurality of prisms that protrude toward the light guide plate 110, and thereby, extend away from the display panel 150.

According to exemplary embodiments, the corresponding portion 112 may linearly extend between the light exiting surface and the bottom surface of the light guide plate 110, such that the corresponding portion 112 appears as a straight line in a plan view, as seen in FIG. 2B. Additionally or alternatively, the corresponding portion 112 may extend non-linearly (e.g., in a curved fashion) between the light exiting surface and the bottom surface of the light guide plate 110, such that the corresponding portion 112 appears as a curved (e.g., arcuate) line in a plan view. For example, the corresponding portion 112 may have a portion protruded in an opposite direction from the light incident portion 111. In this manner, the corresponding portion 112 may be configured to have a convex-concave pattern in a cross-sectional view. According to exemplary embodiments, the corresponding portion 112 may exhibit a sawtooth pattern in a cross-sectional view. It is contemplated; however, that any other suitable shape or formation may be utilized.

A condensing lens 135 may be disposed between the light source part 130 and the light guide plate 110. In this manner, the condensing lens 135 may be configured to adjust a direction of light emitted from the light source part 130 towards the light guide plate 110.

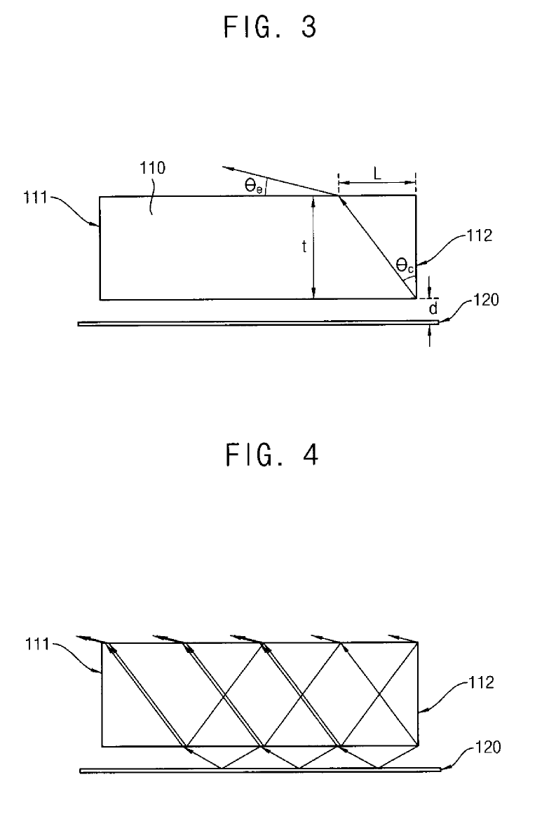

FIG. 3 is a cross-sectional view of a light guide plate and a reflecting element of a backlight unit, according to exemplary embodiments. For descriptive convenience and to ease understanding of exemplary embodiments described herein, the light guide plate of FIG. 3 is illustrated and described in association with a uniform thickness t. As previously mentioned; however, it was noted that the light guide plate 110 may be configured as a wedge or other suitable shape exhibiting a non-uniform thickness.

With continued reference to FIGS. 2A and 2B, the light guide plate 110 of FIG. 3 includes the reflecting element 120 spaced apart from the bottom surface of the light guide plate 110 by a first distance d. In this manner, the reflecting element 120 is configured to reflect incident light. The reflecting element 120 may be formed from (or otherwise include) one or more metals exhibiting a relatively high reflectivity, such as aluminum, gold, silver, and/or the like. The reflecting element 120 may include a resin base layer (not shown) and a reflecting layer (not illustrated) disposed on the resin base layer.

According to exemplary embodiments, light from the light source part 130 may propagate through the light incident portion 111. As such, at least some of the light propagating through the light incident portion 111 may be refracted and reflected at the corresponding portion 112. In this manner, refracting angle θc is related to a refractive index n of the light guide plate 110. Refracting angle θc and the refractive index n of the light guide plate 110 satisfy the following equation:

$${θ}_{c} = {sin}^{- 1} ( \frac{1}{n} ) \qquad Equation 1$$

The light refracted and reflected at the corresponding portion 112 may exit through the light exiting surface. The light exiting through the light exiting surface may have an exiting angle θe. A distance between a light exiting point and the corresponding portion 112 may be defined as L. A distance t between the light exiting surface and the bottom surface may be defined as a thickness t of the light guide plate 110.

Determining the extent of the first distance d may be based on characteristics of the light guide plate 110. For instance, the length of the first distance d may be determined based on the following equation:

$$d = \frac{t}{2} \times tan {θ}_{c} \times tan {θ}_{e} \qquad Equation 2$$

As explained above, t is the thickness of the light guide plate, θc is defined by Equation 1, and n is the refractive index of the light guide plate. As such, θe is the exiting angle at the light exiting surface of the light guide plate 110. The exiting angle θe may be determined by following equation when a wedge angle of the light guide plate is θw (which, again, is not illustrated in FIG. 3):

$${θ}_{e} = {sin}^{- 1} ( n \times sin ( {θ}_{c} - \frac{{θ}_{w}}{2} ) ) \qquad Equation 3$$

FIG. 4 is a cross-sectional view of a path of light of the backlight unit of FIG. 3, according to exemplary embodiments.

Referring to FIG. 4, light received from the light source part 130 is refracted and reflected at a corresponding surface of the corresponding portion 112. The light refracted and reflected at the corresponding surface may exhibit two kinds of paths. The light refracted and reflected at the corresponding surface may be reflected at the bottom surface, and thereby, exit through the light exiting surface or may pass through the bottom surface, be reflected at the reflecting element 120, and thereby, exit through the light exiting surface.

Light directly reflected at the bottom surface may be defined as a first light group. Light passing through the bottom surface and reflected at the reflecting element 120 may be defined as a second light group. Light of the first light group is directly reflected at the bottom surface and exits through the light exiting surface, and thereby, travels along a first path. Light of the second light group passes through the bottom surface, is reflected at the reflecting element 120 and exits through the light exiting surface, and thereby, travels along a second path. The second path is longer than the first path by at least twice the first distance d, i.e., by at least 2d. As such, light of the second light group may have a delayed light distribution proportional to the first distance d.

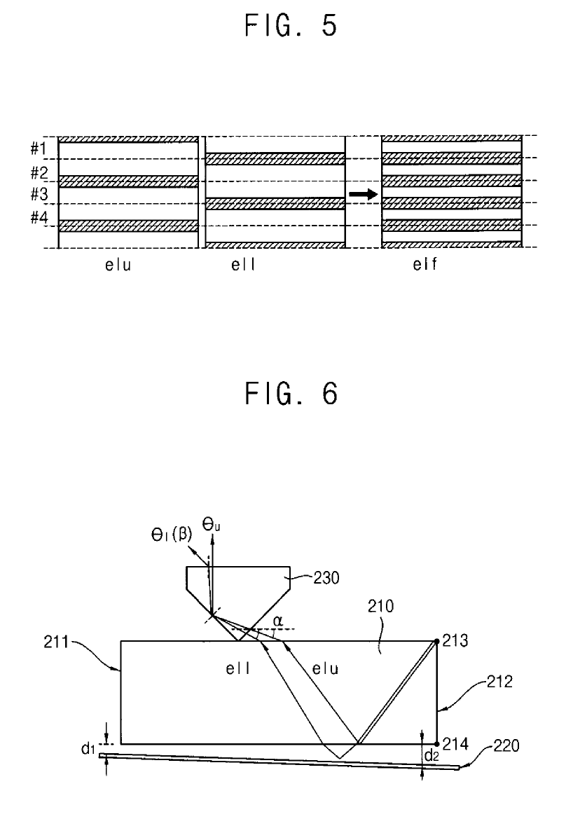

FIG. 5 is a cross-sectional view of a light exiting distribution of the light guide plate of FIG. 3, according to exemplary embodiments.

Referring to FIG. 5, the first light group includes an upper light distribution elu of the light guide plate 110. The second light group includes a lower light distribution ell of the light guide plate 110. The light of the first light group corresponding to the upper light distribution elu of the light guide plate 110 is reflected at the corresponding surface of the corresponding portion 112 of the light guide plate 110, is reflected (e.g., totally reflected) in the light guide plate 110, and exits through the light exiting surface of the light guide plate 110. The light of the second light group corresponding to the lower light distribution ell of the light guide plate 110 is reflected at the corresponding surface of the corresponding portion 112 of the light guide plate 110, is reflected (e.g., totally reflected) in the light guide plate 110, and exits through the bottom surface of the light guide plate 110. The light of the second light group exiting through the bottom surface is reflected at the reflecting element 120 and redirected toward the light guide plate 110, propagates through the light guide plate 110, and exits through the light exiting surface of the light guide plate 110. As such, light of both of the first light group and the second light group exit through the light exiting surface, but the first light group and the second light group have different light distributions from each other resulting, at least in part, from the distance d between the bottom surface of the light guide plate 110 and the reflecting element 120. In this manner, the first light group has the upper light distribution elu of the light guide plate 110, and the second light group has the lower light distribution ell of the light guide plate 110.

The upper light distribution elu of the light guide plate 110 may include a plurality of dark portions (or spots) due to, for instance, the presence of a defective portion of the light guide plate 110. A gap between adjacent dark portions may be related to the number of total internal reflections the light undergoes before exiting the light guide plate 110 so that the gap between adjacent dark portions may be determined based on a thickness t of the light guide plate 110. The gaps between adjacent dark portions may be uniformly distributed across the light guide plate 110. The lower light distribution ell of the light guide plate 110 may include a plurality of dark portions (or spots) due to, for instance, the presence of the defective portion of the light guide plate 110. A gap between adjacent dark portions in the lower light distribution ell of the light guide plate 110 may be equal to the gap between adjacent dark portions in the upper light distribution elu of the light guide plate 110. This is because light of the second light path causing the dark portions associated with the lower light distribution ell undergo a same number of total internal reflections as light associated with the first light path causing the dark portions associated with the upper light distribution elu.

However, the lower light distribution ell is delayed from the upper light distribution elu. This delay is a result of the extra distance the second light group propagates before exiting the light guide plate 110. As such, the lower light distribution ell has a shape (or pattern) substantially the same as the upper light distribution elu, but the lower light distribution ell is a delayed pattern of the upper light distribution elu.

At the light exiting surface of the light guide plate 110, the lower light distribution ell and the upper light distribution elu are added. In a total light distribution elf of the light guide plate 110 corresponding to a sum of the lower light distribution ell and the upper light distribution elu, the dark portions of the lower light distribution ell and the dark portions of the upper light distribution elu are alternately disposed with each other, such that the gap between adjacent dark portions in the total light distribution elf decreases as compared to the lower light distribution ell and the upper light distribution elu. The dark portions of the lower light distribution ell overlap the bright portions of the upper light distribution elu, and the dark portions of the upper light distribution elu overlap the bright portions of the lower light distribution ell. As such, interference patterns (e.g., stripe patterns) resulting from a defective portion of the light guide plate 110 may be decreased.

FIG. 6 is a cross-sectional view of a backlight unit, according to exemplary embodiments.

Referring to FIG. 6, the backlight unit includes a light source part (not shown), a light guide plate 210, and a reflecting element 220. An optical sheet 230 may be disposed on the backlight unit. The light guide plate 210 includes a light incident portion 211, a corresponding portion 212 spaced apart from and facing the light incident portion 211, a light exiting surface, and a bottom surface spaced apart from and facing the light exiting surface. The reflecting element 220 is disposed under the light guide plate 210. The reflecting element 220 is spaced apart from the bottom surface of the light guide plate 210 and is configured to reflect light propagating through the bottom surface. In this manner, the reflecting element 220 is configured to redirect the light back towards the light guide plate 210. The optical sheet 230 may include an inverted prism sheet, such that a prism of the inverted prism sheet extends toward the light guide plate 210 to form an apex. The optical sheet 230 is configured to guide light exiting from the light guide plate 210 in an upwards direction, such as a direction extending away from and normal (or substantially normal) to the light guide plate 210.

As compared with the backlight unit illustrated in association with FIG. 3, the backlight unit of FIG. 6 includes the reflecting element 220 being non-uniformly spaced apart from the light guide plate 210 by a plurality of different distances that range in value between the light incident portion 211 of the light guide plate 210 and the corresponding portion 212 of the light guide plate 210.

According to exemplary embodiments, the reflecting element 220 is spaced apart from the bottom surface of the light guide plate 210 at the light incident portion 211 by a first distance d1. The reflecting element 220 is spaced apart from the bottom surface of the light guide plate 210 at the corresponding portion 212 by a second distance d2. In this manner, the reflecting element 220 is inclined (or declined) with respect to the light guide plate 210, the optical sheet 230, and/or the display panel disposed on the optical sheet 230. As such, the reflecting element 220 may change a characteristic of the light refracted and reflected at a corresponding surface of the corresponding portion 212 and reflected at the reflecting element 220. For example, the first distance d1 may be less than the second distance d2. In this manner, the reflecting element 220 may have a first inclined (or declined) angle with respect to the bottom surface of the light guide plate 210.

As explained above in association with FIG. 3, light provided from the light source part 130 is refracted and reflected at the corresponding surface of the corresponding portion 212. The corresponding surface includes an upper vertex 213 and a lower vertex 214. In FIG. 6, the light reflected at the upper vertex 213 is illustrated.

According to exemplary embodiments, light refracted and reflected at the corresponding surface has two kinds of paths. Light refracted and reflected at the corresponding surface may be directly reflected at the bottom surface, and thereby, exit through the light exiting surface or may pass through the bottom surface, be reflected at the reflecting element 220, propagate through light guide plate 210, and thereby, exit through the light exiting surface.

The light directly reflected at the bottom surface may be defined as a first light group. The light passing through the bottom surface and reflected at the reflecting element 220 may be defined as a second light group. Light of the first light group is directly reflected at the bottom surface and exits through the light exiting surface, such that the light of the first light group travels a first path. Light of the second light group passes through the bottom surface, is reflected at the reflecting element 220, and exits through the light exiting surface, such that the light of the second light group travels a second path. The second path is longer than the first path by at least two times the first distance d1 at the light incident portion 211 and by at least two times the second distance d2 at the corresponding portion 212. In addition, the path of the light of the second light group is changed (e.g., phase shifted) because the reflecting element 220 is inclined (or declined) at the first inclined (or declined) angle.

Referring again to FIG. 6, when light of the second light group exits the light exiting surface of the light guide plate 210, light of the second light group is further refracted by a changed exiting angle α than the light of the first light group. When the changed light of the second light group passes through the optical sheet 230, the changed light of the second light group is not perpendicular to an upper surface of the optical sheet 230, but the changed light of the second light group is further refracted with respect to the perpendicular direction to the upper surface of the optical sheet 230 by a changed distribution angle β. Thus, the light of the first light group exits the optical sheet 230 in the perpendicular direction to the upper surface of the optical sheet 230, and the light of the second light group exits the optical sheet 230 in the inclined direction associated with the changed distribution angle β with respect to the perpendicular direction to the upper surface of the optical sheet 230. This enables the viewing angle to be broader.

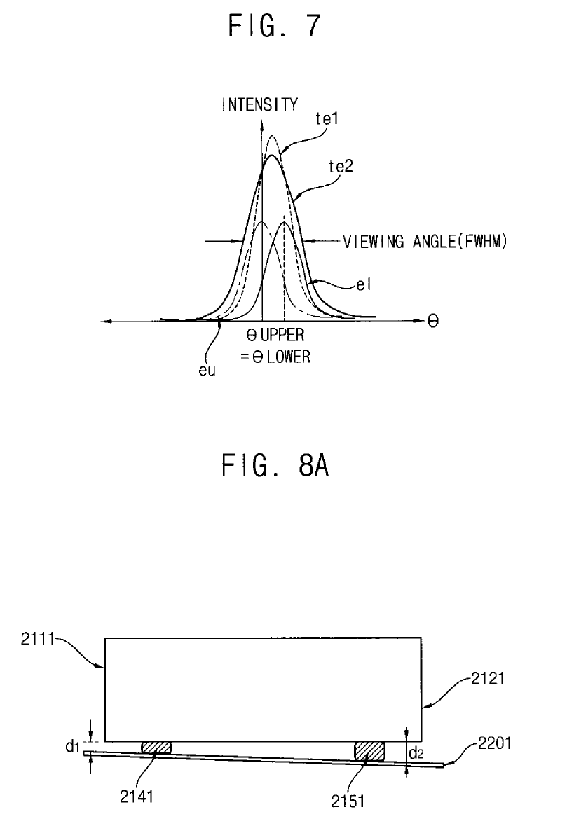

FIG. 7 is a graph of a viewing angle distribution of the backlight unit of FIG. 6, according to exemplary embodiments.

Referring to FIG. 7, the first light group has an upper viewing angle eu. The second light group has a lower viewing angle el. The light of the first light group corresponding to the upper viewing angle eu is reflected at the corresponding surface of the light guide plate 210, is reflected (e.g., totally reflected) in the light guide plate 210, and exits through the light exiting surface of the light guide plate 210.

Light of the second light group corresponding to the lower viewing angle el is reflected at the corresponding surface of the light guide plate 210, is reflected (e.g., totally reflected) in the light guide plate 210, and exits through the bottom surface of the light guide plate 210. The light of the second light group is further refracted by the changed distribution angle β rotated from the perpendicular direction of the upper surface of the optical sheet 230. Thus, the light of the second light group has a delayed light distribution corresponding to the changed distribution angle β.

An upper viewing angle distribution of the conventional light guide plate 12 is substantially the same as a lower viewing angle distribution so that a total viewing angle distribution tel of the conventional light guide plate 12 has a value twice of the upper viewing angle distribution or the lower viewing angle distribution. An intensity of the light is doubled at every region, but a width of the viewing angle distribution is substantially not increased.

However, the lower viewing angle distribution el of the light guide plate 210, according to exemplary embodiments of FIG. 6, is further refracted compared to the upper viewing angle distribution eu of the light guide plate 210, such that a total viewing angle distribution te2 of the light guide plate has a broader shape. In this manner, the viewing angle of the display apparatus may be broader than a conventional display apparatus.

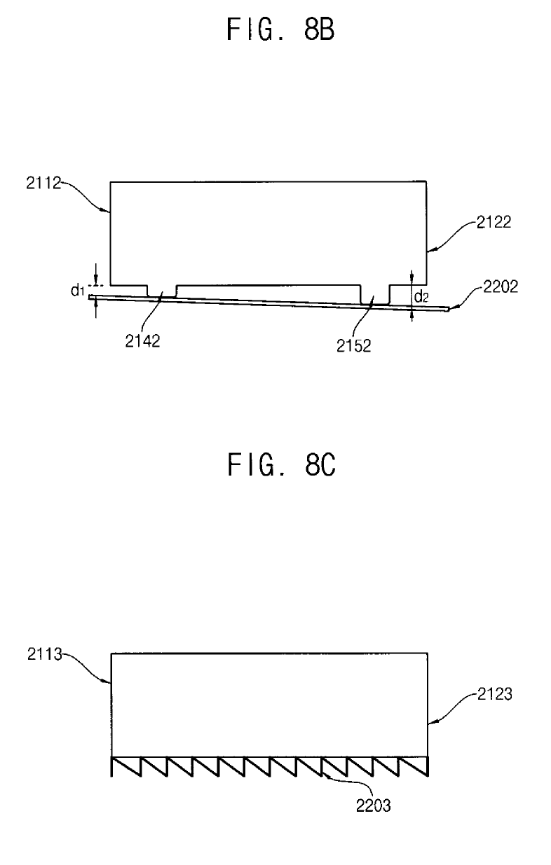

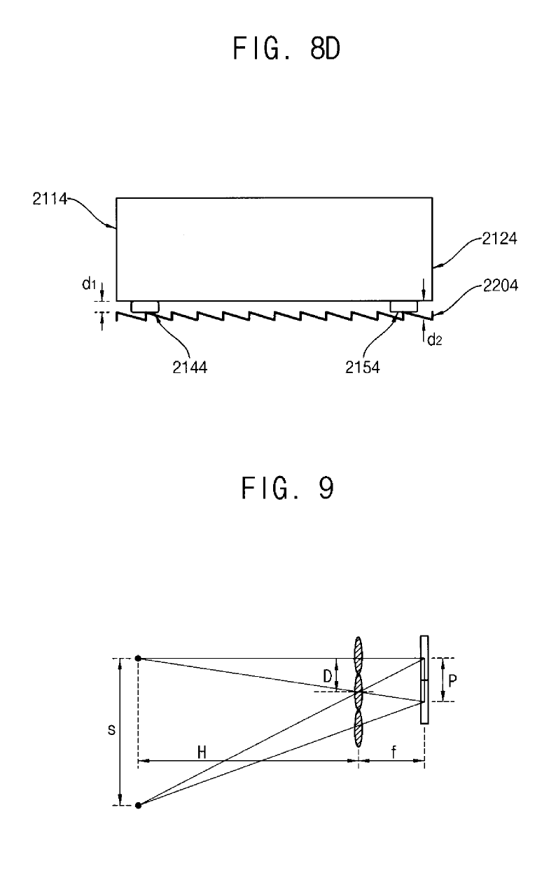

FIGS. 8A-8D are cross-sectional views of backlight units, according to exemplary embodiments.

The backlight unit of FIG. 6 may be configured as shown in FIG. 8A. Referring to FIG. 8A, the backlight unit includes a light guide plate, a reflecting element 2201, a first spacer 2141, and a second spacer 2151. The light guide plate includes a light incident portion 2111 and a corresponding portion 2121 spaced apart from and facing the light incident portion 2111.

Shape and functions of the light guide plate and the reflecting element 2201 are substantially the same as those described in association with FIG. 6. As seen in FIG. 8A, however, the backlight unit includes the first spacer 2141 configured to form a gap of the first distance d1 below the light incident portion 2111 and the second spacer 2151 configured to form a gap of the second distance d2 below the corresponding portion 2121. As such, the first spacer 2141 and the second spacer 2151 enable the reflecting element 2201 to be spaced apart from the light guide plate by the first distance d1 and the second distance d2. The first spacer 2141 and the second spacer 2151 are disposed between the reflecting element 2201 and the light guide plate to form the gaps of the first distance d1 and the second distance d2. In this manner, the reflecting element 2201 may be spaced apart from the light guide plate, and the reflecting element 2201 may have an inclined (or declined) angle with respect to a bottom surface of the light guide plate.

Additionally or alternatively, the backlight unit of FIG. 6 may be configured as shown in FIG. 8B. Referring to FIG. 8B, the backlight unit includes a light guide plate, a reflecting element 2202, a first protruding portion 2142, and a second protruding portion 2152. The light guide plate includes a light incident portion 2112 and a corresponding portion 2122 spaced apart from and facing the light incident portion 2112.

Shape and functions of the light guide plate and the reflecting element 2202 are substantially the same as those described in association with FIG. 6. As seen in FIG. 8B, however, the backlight unit includes the first protruding portion 2142 configured to form a gap of the first distance d1 below the light incident portion 2112 and the second protruding portion 2152 configured to form a gap of the second distance d2 below the corresponding portion 2122. As such, the first protruding portion 2142 and the second protruding portion 2152 enable the reflecting element 2202 to be spaced apart from the light guide plate by the first distance d1 and the second distance d2.

The first protruding portion 2142 and the second protruding portion 2152 may be formed as portions of the light guide plate. The first protruding portion 2142 and the second protruding portion 2152 may extend from the light guide plate. For example, the first protruding portion 2142 and the second protruding portion 2152 may be protruded from a bottom surface of the light guide plate, such that the first protruding portion 2142 and the second protruding portion 2152 are integrally formed with the light guide plate. As such, the reflecting element 2202 may be spaced apart from the light guide plate by the first protruding portion 2142 and the second protruding portion 2152, and the reflecting element 2202 may have an inclined (or declined) angle with respect to a bottom surface of the light guide plate.

Additionally or alternatively, the backlight unit of FIG. 6 may be configured as shown in FIG. 8C. Referring to FIG. 8C, the backlight unit includes a light guide plate and a reflecting element 2203. The light guide plate includes a light incident portion 2113 and a corresponding portion 2123 spaced apart from and facing the light incident portion 2113.

Shape and functions of the light guide plate and the reflecting element 2203 are substantially the same as those described in FIG. 6. As seen in FIG. 8C, however, the backlight unit does not include an additional element to form gaps of the first distance d1 and the second distance d2. The reflecting element 2203 includes a plurality of reflecting portions having corresponding reflecting angles. The reflecting portions may have a sawtooth pattern. The reflecting element 2203 may be formed from the reflecting portions, such as to form a Fresnel lens. The reflecting element 2203 may be formed by combining the reflecting portions so that the reflecting element 2203 includes the reflecting angle. In this manner, the reflecting element 2203 may be configured as a reflecting element including a single reflecting portion having the reflecting angle. As such, light transmitted to the reflecting element 2203 may be reflected by the reflecting angle of the reflecting element 2203.

According to exemplary embodiments, the reflecting element 2203 includes the plurality of the reflecting portions so that the additional element to form gaps of the first distance d1 and the second distance d2 is not required. As such, a gap between the reflecting element 2203 and the light guide plate may be decreased, and thereby, enable the formation of a thinner display apparatus. For example, the reflecting element 2203 may be disposed directly on (or abut) the bottom surface of the light guide plate.

Additionally or alternatively, the backlight unit of FIG. 6 may be configured as shown in FIG. 8D. Referring to FIG. 8D, the backlight unit includes a light guide plate, a reflecting element 2204, a first spacer 2144, and a second spacer 2154. The light guide plate includes a light incident portion 2114 and a corresponding portion 2124 spaced apart from and facing the light incident portion 2114.

Shape and functions of the light guide plate and the reflecting element 2204 are substantially the same as those described in association with FIG. 6. As seen in FIG. 8D, however, the backlight unit includes the first spacer 2144 and the second spacer 2154, which may be formed similarly to the first spacer 2141 and the second spacer 2151 of FIG. 8A, but the first spacer 2144 and the second spacer 2154 of FIG. 8D may be of a same thickness. The reflecting element 2204 includes a plurality of reflecting portions, such as described in association with FIG. 8C.

The reflecting element 2204 includes the reflecting portions including corresponding reflecting angles. The reflecting portions may have a sawtooth pattern. The reflecting element 2204 may be formed from the reflecting portions, such as to form a Fresnel lens. The reflecting element 2204 may be formed by combining the reflecting portions so that the reflecting element 2204 has the reflecting angle. In this manner, the reflecting element 2204 may be configured as a reflecting element including a single reflecting portion having the reflecting angle. As such, light transmitted to the reflecting element 2204 may be reflected by the reflecting angle of the reflecting element.

Additionally, the first spacer 2144 and the second spacer 2154 enable the reflecting element 2204 to be spaced apart from the light guide plate by the first distance d1 and the second distance d2. In this manner, the first spacer 2144 may be less thick than the second spacer 2154. As previously described, the light guide plate enables stripe patterns to be prevented (or otherwise reduced) and the viewing angle of a corresponding display apparatus to be adjusted, e.g., broadened.

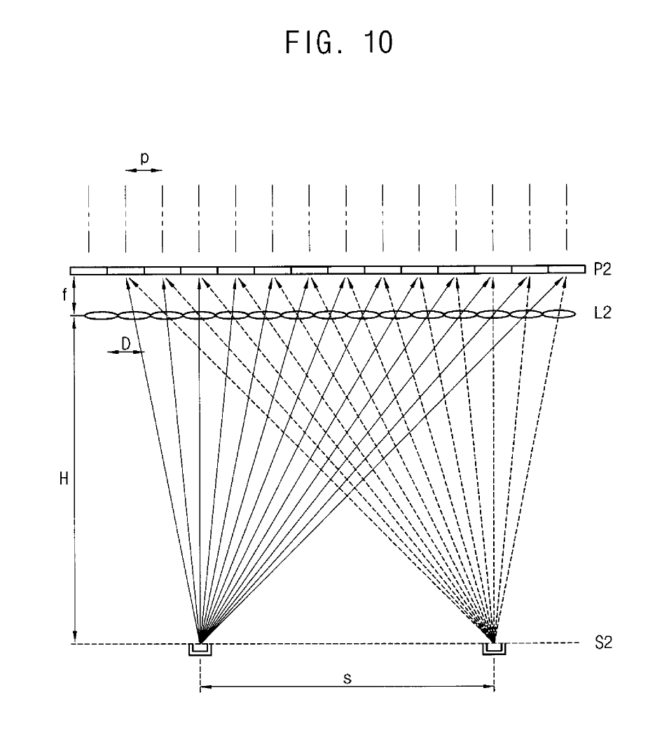

FIG. 9 is a conceptual diagram of a display apparatus, according to exemplary embodiments. FIG. 10 is a conceptual diagram of the display apparatus of FIG. 9, according to exemplary embodiments.

Referring to FIG. 9, the display apparatus includes a light source, a lens, and a plurality of pixels. In FIG. 9, only some parts of the display apparatus are shown to explain a path of light from the light source. Light emitted from the plurality of light sources passes through the optical elements, such as the light guide plate, and is transmitted to the lens. Light emitted from the plurality of light sources travels a distance H. The lens is spaced apart from the plurality of pixels by a focal length f. Light refracted at the lens is transmitted to the plurality of pixels. When a pitch of the light sources is a light source distance s, a pitch of the lens is a lens pitch D, the focal length of the lens is a focal length f and a pitch of the plurality of pixels is a pixel pitch p, the following equations are satisfied:

$$\begin{matrix}\frac{s}{H} = \frac{p}{f} & Equation 4 \\ \frac{p}{H + f} = \frac{D}{H} & Equation 5 \\ D = \frac{pH}{H + f} = \frac{sf}{H + f} & Equation 6\end{matrix}$$

Referring to FIG. 10, when a magnification of the lens is M, the following equation is satisfied:

$$M = \frac{H}{f} = \frac{s}{p} \qquad Equation 7$$

Thus, when the magnification M of the lens is an integer, light emitted from the light sources are condensed at a same point in the display panel.

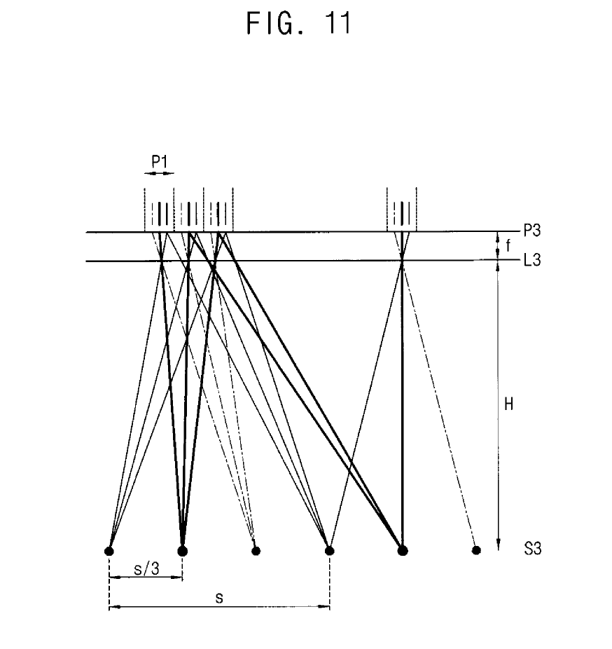

FIG. 11 is a conceptual diagram of a backlight unit of the display apparatus of FIG. 9, according to exemplary embodiments.

Referring to FIG. 11, three light sources are disposed in association with the light source distance s. For example, a red light source, a green light source, and a blue light source may be utilized to generate white light. The red, green and blue light sources may be spaced apart from one another by a sub light source distance s/3, which is one third (⅓) the light source distance s. The light source lens distance H is a distance between the light source and the lens, and may be the same distance as the light source lens distance H in FIG. 9. The focal length f is a distance between the lens L3 and a lens panel P3 including a plurality of the pixels, and may be the same as the focal length f in FIG. 9. The focal length f may be a distance between the lens L3 and the lens panel P3 or a distance between the lens L3 and the respective pixel P1.

The red light, the green light, and the blue light may be disposed in the single light source distance s and may have their emitted lights correspondingly condensed at the single pixel P1. As such, even though three different light sources are disposed and spaced apart from one another, white light may be generated at the pixel P1 by adding the three different wavelengths of light. As such, a color filter is not required in the display apparatus of FIG. 11.

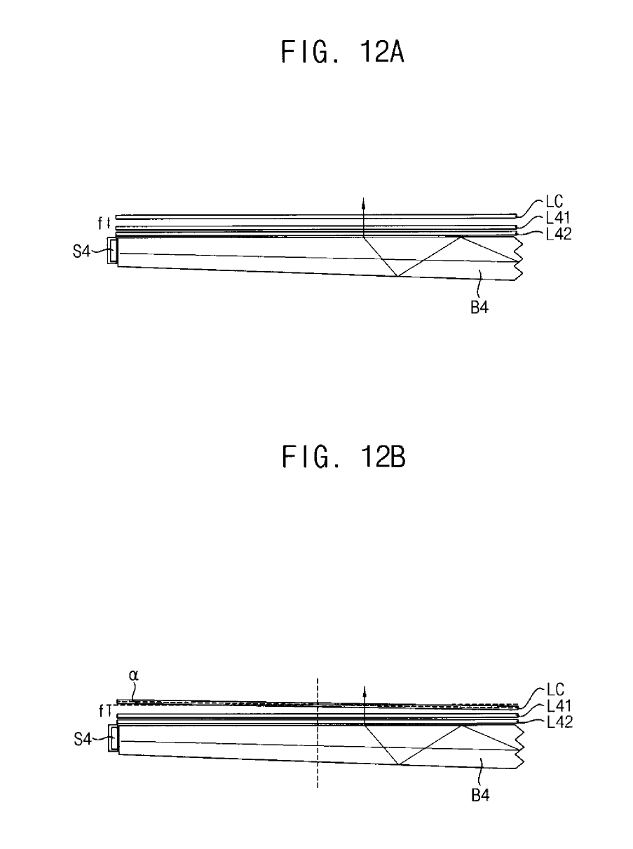

FIGS. 12A and 12B are cross-sectional views of the backlight unit of the display apparatus of FIG. 9, according to exemplary embodiments.

Referring to FIG. 12A, the backlight unit includes a light source S4, a light guide plate B4, an optical film L42, and a condensing lens L41. Light emitted from the backlight unit is provided to a display panel LC disposed on the backlight unit.

The condensing lens L41 is spaced apart from the display panel LC by the focal length f. According to exemplary embodiments, the focal length f is a gap distance between the condensing lens L41 and the display panel LC and is uniform.

Referring again to Equation 7, the focal length f and the lens distance H may be configured to be proportional to each other to maintain a uniform magnification of the lens. The lens distance H is a distance between the light source S4 and the condensing lens L41, such that the focal length f is increased as a path of the light from the light source S4 to the condensing lens L41 increases as a distance from the light source S4 increases. Light from the light source S4 may be reflected at the corresponding surface of the light guide plate B4 and reflected (e.g., totally reflected) in the light guide plate B4, and thereby, exit the light guide plate B4 to be provided to the display panel LC. As such, light exiting the light guide plate B4 at a position closer to the light source S4 has a relatively longer lens distance H. To compensate for the difference of the lens distance H, the focal length f may be increased as a distance from the light source S4 decreases.

FIG. 12B illustrates an exemplary embodiment to compensate for the above-noted issue. In FIG. 12B, the display panel LC is inclined by an angle α with respect to the display panel LC in FIG. 12A. When the display panel LC is inclined by the angle α, the focal length f may be changed in accordance with the lens distance H from the light source S4.

For example, the lens distance H of light exiting a portion corresponding to the light incident portion of the light guide plate adjacent to the light source S4 is relatively longer because the light exiting the portion corresponding to the light incident portion of the light guide plate B4 is further displaced by a length of the light guide plate B4 as compared to a light exiting a portion corresponding to the corresponding portion of the light guide plate B4. Thus, the focal length f corresponding to the light incident portion of the light guide plate B4 may be increased. The display panel LC is inclined by the angle α so that the focal length f corresponding to the light incident portion may have a relatively longer focal length f.

In contrast, the lens distance H of the light exiting a portion corresponding to the corresponding portion of the light guide plate B4 is relatively smaller because the light exiting the portion corresponding to the corresponding portion of the light guide plate B4 is displaced by the length of the light guide plate B4. As such, the focal length f corresponding to the corresponding portion of the light guide plate B4 may be decreased. The display panel LC is inclined by the angle α so that the focal length f corresponding to the corresponding portion may have a relatively shorter focal length f.

Accordingly, the focal length f between the condensing lens L41 and the display panel LC (or the pixel P1) may be different according to a position of the light guide plate B4 so that display defects may be decreased.

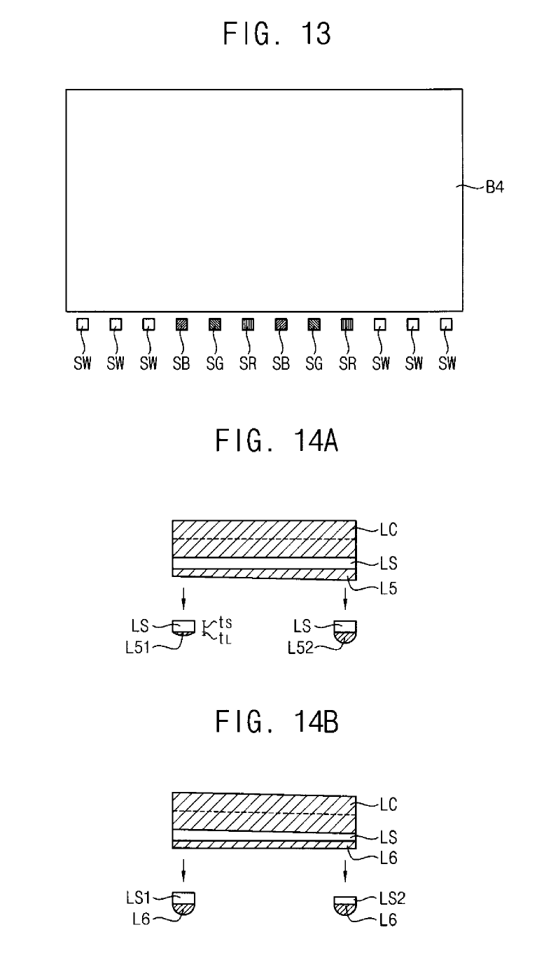

FIG. 13 is a plan view of a backlight unit, according to exemplary embodiments.

Referring to FIG. 13, the backlight unit includes a light guide plate B4 and a plurality of light sources SW, SB, SR and SG. The light guide plate B4 may have a rectangular shape in a plan view; however, any other suitable configuration may be utilized. A conventional light guide plate may have a wedge shape and the corresponding portion of the light guide plate may include a reflecting surface having a uniform curvature so that a display defect due to a difference in lengths of paths of the light may be prevented. However, the corresponding portion of the light guide plate B4 according to exemplary embodiments may compensate for the difference in lengths of paths of light using the variably established focal length f extending between the condensing lens L41 and the pixels of display panel LC. As such, the corresponding portion of the light guide plate B4 may be viewed as a straight line in a plan view.

The light sources may correspond to a white light source SW, a blue light source SB, a red light source SR, and a green light source SG. The white light source SW may be disposed adjacent to a side portion of the light guide plate B4. The blue, red, and green light sources SB, SR, and SG may be disposed adjacent to a central portion of the light guide plate B4. When the red, green, and blue light sources SR, SG, and SB are sequentially disposed adjacent to the side portion of the light guide plate B4, the red light, the green light, and the blue light may be reflected at a side surface of the light guide plate B4 so that the blue light, the green light, and the red light may be sequentially provided to pixels of the display panel LC. As such, the white light source SW may be disposed adjacent to the side portion of the light guide plate to prevent a display defect due to color mixing.

FIGS. 14A and 14B are cross-sectional views of backlight units, according to exemplary embodiments.

Exemplary embodiments described in association with FIGS. 14A and 14B may be adapted from exemplary embodiments described in association with FIG. 12B.

Referring to FIG. 14A, the backlight unit includes a display panel LC, a lens substrate LS, a condensing lens part L5, and a light guide plate. In FIG. 14A, for convenience of explanation the light guide plate is not illustrated. The light guide plate is configured to guide light from a light source (not shown) toward the display panel LC, e.g., in an upwards direction.

As described in association with FIG. 12B, the focal length f between the display panel LC and the condensing lens part L5 may be adjusted to prevent display defects. As seen in FIG. 14A, the focal length may be adjusted by changing a height of the condensing lens part L5. The condensing lens part L5 may include a plurality of sub lenses L51 and L52. As shown in FIG. 14A, a height tL of a first sub lens L51 corresponding a first portion of the display panel may be relatively smaller than a height tL of a second sub lens L52 corresponding to a second portion of the display panel. This enables the focal length to be adjusted. A height is of the lens substrate LS may be uniform.

Referring to FIG. 14B, the backlight unit includes a display panel LC, a lens substrate LS, a condensing lens part L6, and a light guide plate. In FIG. 14B, for convenience of explanation the light guide plate is not illustrated. The light guide plate is configured to guide light from the light source toward the display panel LC, e.g., in an upwards direction.

As described in association with FIG. 12B, the focal length f between the display panel LC and the condensing lens part L5 may be adjusted to prevent display defects. As seen in FIG. 14B, the focal length may be adjusted by changing a height of the lens substrate LS. The height of the condensing lens part L6 may be uniform. The condensing lens part L6 may include a plurality of sub lenses. As shown in FIG. 14B, a height of a first portion LS1 of the lens substrate LS corresponding to a first portion of the display panel LC may be relatively bigger and a second portion LS2 of the lens substrate LS corresponding to a second portion of the display panel LC may be relatively smaller so that the focal length may be adjusted. As such, a display defect due to differences in the lens distances H between the light source and the lens may be prevented (or otherwise reduced). Accordingly, a backlight unit for a display apparatus without a color filter may be manufactured. In addition, the backlight unit including the light guide plate having the corresponding portion appearing as straight line in a plan view may be manufactured.

According to the exemplary embodiments, a reflecting element may be spaced apart from a light guide plate to adjust a light distribution pattern of light exiting the light guide plate so that display defects, e.g., dark spots of a stripe pattern, may be prevented (or reduced) even when a defective portion is included in the light guide plate.

According to exemplary embodiments, an inclined angle between a reflecting element and a light guide plate may be adjusted to adjust a light distribution pattern of light exiting the light guide plate. As such, light having a wider viewing angle distribution may be generated.

According to exemplary embodiments, a focal length between a condensing lens and a pixel may be adjusted so that an error due to a difference in light paths according to positions of respective light sources may be prevented (or otherwise reduced). As such, a backlight unit for a display apparatus without a color filter may be manufactured.

According to exemplary embodiments, a focal length between a condensing lens and a pixel may be adjusted so that display defects due to a difference in light paths according to positions of respective light sources is prevented (or otherwise reduced). As such, the light guide plate having a rectangular shape without a curved corresponding side may be manufactured, which further enables a corresponding bezel of the display apparatus to be decreased in size.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A backlight unit, comprising:
a light source part configured to provide light;
a light guide plate comprising:
a light incident portion disposed adjacent to the light source part,
a corresponding portion spaced apart from and facing the light incident portion,
a light exiting surface, and
a bottom surface spaced apart from and facing the light exiting surface,
wherein a thickness of the light incident portion is greater than a thickness of the corresponding portion;
a prism sheet disposed on the light guide plate, the prism sheet comprising a plurality of prisms extending toward the light guide plate; and
a reflecting element disposed under the light guide plate, the reflecting element being configured to reflect at least some of the light toward the light guide plate.

2. The backlight unit of claim 1, wherein the reflecting element is spaced apart from the bottom surface of the light guide plate.

3. The backlight unit of claim 2, wherein a distance between the reflecting element and the light guide plate is d and d is defined as follows:
$$d = \frac{t}{2} \times tan {θ}_{c} \times tan {θ}_{e} ,$$
wherein:
t is a thickness of the light guide plate extending between the light exiting surface and the bottom surface,
$$θ c = {sin}^{- 1} ( \frac{1}{n} ) ,$$
n is a refractive index of the light guide plate, and
θe is an exiting angle at which at least some of the light exits the exiting surface of the light guide plate.

4. The backlight unit of claim 2, wherein the reflecting element is spaced further from the corresponding portion than the light incident portion.

5. The backlight unit of claim 4, further comprising:
a first spacer and a second spacer, the first and second spacers being disposed between the light guide plate and the reflecting element,
wherein a thickness of the first spacer is different than a thickness of the second spacer.

6. The backlight unit of claim 4, further comprising:
a first protruding portion and a second protruding portion, the first and second protruding portions extending from the bottom surface of the light guide plate toward the reflecting element,
wherein a height of the first protruding portion is different than a height of the second protruding portion.

7. The backlight unit of claim 2, wherein the reflecting element comprises a sawtooth pattern.

8. The backlight unit of claim 1, wherein the reflecting element is disposed directly on the bottom surface of the light guide plate.

9. The backlight unit of claim 8, wherein the reflecting element comprises a sawtooth pattern.

10. The backlight unit of claim 1, wherein the corresponding portion comprises a linear reflective surface or a curved reflective surface.

11. The backlight unit of claim 1, wherein the corresponding portion comprises a convex-concave pattern.

12. The backlight unit of claim 1, further comprising:
a condensing lens disposed between the light source part and the light guide plate.

13. A display apparatus comprising:
a backlight unit; and
a display panel configured to display an image using light received from the backlight unit,
wherein the backlight unit comprises:
a light source part configured to provide light,
a light guide plate comprising:
a light incident portion disposed adjacent to the light source part,
a corresponding portion spaced apart from and facing the light incident portion,
a light exiting surface, and
a bottom surface spaced apart from and facing the light exiting surface,
wherein a thickness of the light incident portion is greater than a thickness of the corresponding portion,
a prism sheet disposed on the light guide plate, the prism sheet comprising a plurality of prisms extending toward the light guide plate, and
a reflecting element disposed under the light guide plate, the reflecting element being configured to reflect at least some of the light toward the light guide plate.

14. The display apparatus of claim 13, wherein the reflecting element is spaced apart from the bottom surface of the light guide plate.

15. The display apparatus of claim 14, wherein a distance between the reflecting element and the light guide plate is d and d is defined as follows:
$$d = \frac{t}{2} \times tan {θ}_{c} \times tan {θ}_{e} ,$$
wherein:
t is a thickness of the light guide plate extending between the light exiting surface and the bottom surface,
$$θ c = {sin}^{- 1} ( \frac{1}{n} ) ,$$
n is a refractive index of the light guide plate, and
θe is an exiting angle at which at least some of the light exits the exiting surface of the light guide plate.

16. The display apparatus of claim 14, wherein the reflecting element is spaced further from the corresponding portion than the light incident portion.

17. The display apparatus of claim 16, wherein the backlight unit further comprises:
a first spacer and a second spacer, the first and second spacers being disposed between the light guide plate and the reflecting element,
wherein a thickness of the first spacer is different than a thickness of the second spacer.

18. The display apparatus of claim 16, wherein the backlight unit further comprises:
a first protruding portion and a second protruding portion, the first and second protruding portions extending from the bottom surface of the light guide plate toward the reflecting element,
wherein a height of the first protruding portion is different than a height of the second protruding portion.

19. The display apparatus of claim 14, wherein the reflecting element comprises a sawtooth pattern.

20. The display apparatus of claim 13, wherein the reflecting element is disposed directly on the bottom surface of the light guide plate, and the reflecting element comprises a sawtooth pattern.

21. The display apparatus of claim 13, wherein the display panel is inclined with respect to the light exiting surface.

22. The display panel of claim 13, further comprising:
a condensing lens part disposed between the light guide plate and the display panel,
wherein the condensing lens part comprises a thickness that increases as the condensing lens part extends away from the light source part.

23. The display pane of claim 13, further comprising:
a lens substrate disposed between the light guide plate and the display panel,
wherein the lens substrate comprises a thickness that increases as the lens substrate extends away from the light source part.
